(19) United States
(12) Patent Application Publication
(10) Pub. No.: US 2009/0270533 A1
(43) Pub. Date: Oct. 29, 2009

(54) HEAT-CURABLE POWDER COATING COMPOSITION

(75) Inventors: Takafumi Umehara, Yokohama (JP); Atsushi Takahashi, Yokohama (JP); Rijun Nabeshima, Yokohama (JP)

Correspondence Address: Mary E. Golota;Cantor Colburn LLP, 201 W. Big Beaver Road, Suite 1101, Troy, MI, 48084, US

(73) Assignee: BASF COATINGS JAPAN LTD., Yokohamashi (JP)

(21) Appl. No.: 12/302,609

(22) PCT Filed: Apr. 26, 2007
(86) PCT No.: PCT/IB07/01183

§ 371 Date: Jun. 24, 2009

(30) Foreign Application Priority Data
May 29, 2006 (JP) JP 2006-147926

(51) Int. Cl. C09D 163/00; C09D 5/08

(52) U.S. Cl. 523/201; 523/400

(57) ABSTRACT

Disclosed is a heat-curable powder coating composition that allows the formation of a coating film having outstanding long-term corrosion resistance, as well as outstanding chipping resistance, flexibility, and adhesion.

The disclosed heat-curable powder coating composition is characterized by a resin having crosslinkable functional groups that are solid at room temperature (A), a curing agent capable of reacting with said crosslinkable functional groups (B), a fibrous filler (C), and heat-expandable resin particles (D).

### TECHNOLOGICAL FIELD

The present invention concerns a powder coating composition that allows the formation of a coating film having outstanding long-term corrosion resistance, as well as outstanding chipping resistance and flexibility. More specifically, it concerns a heat-curable coating composition that can be optimally used as a coating for automotive underbody components and allows the formation of a coating film that not only has outstanding long-term corrosion resistance, but also shows outstanding resistance to chipping resulting from rocks, etc. that bounce up while driving, and flexibility and adhesion with respect to deformation of automobile components.

### PRIOR ART

Conventionally, epoxy resin-type powder coatings have been widely used in automotive components. Moreover, in order to improve the impact resistance of films, the technology is known of using a powder composition to which an organic foaming agent has been added in the epoxy resin (cf. Patent Documents 1, 2, 3). Cured materials obtained from epoxy resin powder compositions containing foaming agents contain air bubbles in their interior, making them superior in resistance to mechanical impact and thermal impact than cured materials obtained from compositions not containing foaming agents.

However, the cured materials obtained from epoxy resin powder compositions containing foaming agents known in the art are in a state composed of large amounts of air bubbles continuously connected throughout the entire cured material, providing an inferior result with respect to long-term anticorrosion properties and chipping resistance. Moreover, when such compositions are heated and cured, when the composition reaches its foaming temperature, it rapidly produces foam, resulting in the problem that foaming control becomes difficult.

In order to alleviate this problem, an epoxy resin powder composition composed of epoxy resin, anhydrides, and alkali metal carbonates has been disclosed (cf. Patent Document 4).

However, this epoxy resin powder composition shows improper distribution of numerous bubbles on the contact surface of the cured material and the substrate during film molding, causing the drawback that the resulting film shows poor chipping resistance and flexibility/adhesion.

Moreover, a vibration control powder coating containing a modified epoxy resin, a fibrous filler, and a flake filler, and a foaming agent has been disclosed as a means for stopping vibration and noise in mechanical devices having rotating parts (cf. Patent Document 5). Cured materials obtained from this composition show outstanding chipping resistance. However, as they contain large amounts of continuously connected air bubbles in the cured material, they show poor long-term corrosion resistance.

[Patent Document 1] Japanese Unexamined Patent Application No. S63-273652

[Patent Document 2] Japanese Unexamined Patent Application No. H05-148429

[Patent Document 3] Japanese Unexamined Patent Application No. H05-148430

[Patent Document 4] Japanese Unexamined Patent Application No. H06-041340

[Patent Document 5] Japanese Unexamined Patent Application No. S59-176358

### PRESENTATION OF THE INVENTION

### Problems to be Solved by the Invention

The purpose of the present invention is to provide a heat-curable powder coating composition allowing the formation of a coating film showing outstanding long-term corrosion resistance, as well as outstanding chipping resistance, flexibility, and adhesion.

### Means for Solving the Problems

The authors of the present invention conducted thorough research in order to achieve the above purpose, and they discovered that by using a resin containing crosslinkable functional groups, a curing agent capable of reacting with said groups, a fibrous filler, and heat-expandable resin particles, it becomes possible to obtain a resin that allows the formation of a coating film showing outstanding corrosion resistance, as well as outstanding chipping resistance and flexibility, thus arriving at the present invention.

Specifically, the present invention provides a heat-curable powder coating composition, characterized by comprising a resin containing crosslinkable functional groups that are solid at room temperature (A), a curing agent capable of reacting with these crosslinkable functional groups (B), a fibrous filler (C), and heat-expandable resin particles (D).

Moreover, the invention provides a heat-curable powder coating composition characterized by containing 1-100 parts by mass of the fibrous filler (C) and 0.1-20 parts by mass of the heat-expandable resin particles (D) with respect to a total of 100 parts by mass of the resin containing crosslinkable functional groups that are solid at room temperature (A) and the curing agent capable of reacting with said crosslinkable functional groups (B).

The invention also provides a heat-curable powder coating composition characterized in that the resin containing crosslinkable functional groups that are solid at room temperature (A) is an epoxy resin, and in that the curing agent capable of reacting with said crosslinkable functional groups (B) is at least one substance selected from an amine, polyamine, dihydrazide, dicyandiamide, imidazole, or phenol resin, a carboxyl group-containing polyester resin, a dibasic acid, and an acid anhydride.

Furthermore, the invention provides a heat-curable powder coating composition characterized in that the average fiber diameter of the fibrous filler (C) is 1-30 μm, its average fiber length is 50 μm-500 μm, and its aspect ratio is 5-500.

The invention also provides a heat-curable powder coating composition characterized in that the resin containing crosslinkable functional groups that are solid at room temperature (A) is an epoxy resin, and in that it contains 1-50 parts by weight of polymer microparticles having a core-shell structure with respect to 100 parts by weight of the epoxy resin.

### EFFECT OF THE INVENTION

The heat-curable powder coating composition of the present invention has the effect of providing outstanding long-term heat resistance and allowing the formation of a coating film with outstanding chipping resistance and flexibility.

Moreover, using the heat-curable powder coating composition of the present invention as a coating for automotive underbody components has the effect of preventing rust due to chipping and peeling caused by rocks that bounce up during driving in cold areas in which snow melting agents such as rock salt are used, thus making it possible to protect the lower components of the automobile body over a long period of time.

### DESCRIPTION OF PREFERRED EMBODIMENTS

The resin containing crosslinkable functional groups that are solid at room temperature using the heat-curable coating composition of the present invention (A) is solid at room temperature (25° C.). Preferably, its softening point is 160° C. or below, with a softening point of 150° C. or below being particularly preferred. The lower limit is 60° C. or above. If the softening point exceeds 160° C., the external appearance of the coating will be impaired, and if it is less than 60° C., the storage stability of the powder coating (antiblocking properties) will be insufficient. There are no restrictions on the type of resin for powder coating use, provided that it is a resin for a conventionally used heat-curable powder coating. Examples of resins having crosslinkable functional groups include epoxy resin, polyester resin, and acrylic resin, with epoxy resin being particularly preferred.

Examples of this epoxy resin include aliphatic epoxy resins such as bisphenol A epoxy resin, bisphenol F epoxy resin, phenol novolac or cresol novolac epoxy resin, cyclic epoxy resin, hydrogenated bisphenol A or AD epoxy resin, propylene glycol diglycidyl ether, pentaerythritol polyglucidyl ether, epoxy resins obtained from aliphatic or aromatic carboxylic acids and epichlorohydrin, epoxy resins obtained from aliphatic or aromatic amines and epichlorohydrin, heterocyclic epoxy resins, spiro ring-containing epoxy resins, and epoxy modified resins.

As needed, one may blend in liquid epoxy resins with the epoxy resin in a range such that the composition obtained will not undergo blocking during storage. The epoxy equivalent of said epoxy resin should be 150-3000 g/eq, and preferably 170-2500 g/eq, with a figure of 200-2000 g/eq being particularly preferred.

As the epoxy resin, a polymer microparticle dispersion-type epoxy resin having a core-shell structure, in which polymer microparticles having a core-shell structure are dispersed in the epoxy resin, is preferred. By evenly dispersing polymer microparticles having a core-shell structure in the epoxy resin, one can further impart the properties of high adhesion, low internal stress, and durability to the heat-curable powder coating composition. In particular, this contributes toward improving chipping resistance at low temperatures. By first dispersing in the epoxy resin polymer microparticles having a core-shell structure, the above properties can be more easily achieved, as one obtains more uniform dispersibility than in cases where polymer microparticles having a core-shell structure are added as is to the powder coating composition during manufacturing thereof.

As example of polymer microparticles having a core-shell structure, one can mention polymer microparticles having a core-shell structure composed of a rubber core layer and a hardened shell layer. The average particle diameter of the polymer microparticles having a core-shell structure should preferably be 0.1-1 μm.

An example of a rubber material composed of a core layer is a copolymer of glycidyl group-containing ethylenically unsaturated monomers and other ethylenically unsaturated monomers.

Moreover, an example of hard substances having shell structures include a copolymer of a hydroxyl group-containing ethylene unsaturated monomer and other ethylene unsaturated monomers and a copolymer composed of carboxylic group-containing ethylene unsaturated monomers and other ethylene unsaturated monomers.

The amount of the polymer microparticles having a core-shell structure in 100 parts by mass of a polymer microparticle dispersion-type epoxy resin having a core-shell structure should be 1-50 parts by mass, and preferably 5-40 parts by mass, with a content of 10-20 parts by mass being particularly preferred. An example of a commercial product of this type of polymer microparticle dispersion-type epoxy resin having a core-shell structure include Epotohto YR-628 and YR-693, manufactured by Tohto Kasei Co., Ltd., etc.

Furthermore, the content ratio of the polymer microparticles having a core-shell structure in the total amount of the epoxy resin should be 1-50 parts by weight with respect to 100 parts by weight of the total epoxy resin, and preferably 1.5-30 parts by mass, with an amount of 2-20 parts by mass being particularly preferred, and an amount of 3-20 parts by mass being even more preferred.

Examples of the curing agent (B) used in the heat-curable coating composition of the present invention include curing agents such as polyester resins containing amines, polyamide, dicyandiamide, hydrazide, imidazole, phenol, and carboxyl groups, amidoimides, dibasic acids, and anhydrides, with dihydrazide adipate, dicyandiamide, phenol resin, carboxyl group-containing polyester resin, and dihydrochloric acid, etc., being preferred, and dihydrazide adipate, dicyandiamide, and phenol resin are particularly preferred.

Moreover, there are no particular restrictions on the carboxyl group-containing polyester resin, with specific examples including a polyester resin having 2 or more carboxylic acid groups per molecule, such as resins obtained by condensation polymerization according to the usual method using an acid constituent having a polyvalent carboxylic acid as its main component and an alcohol constituent having a polyhydric alcohol as its main component as raw materials.

There are no particular restrictions on the aforementioned acid components, with examples including aromatic dicarboxylic acids such as terephthalic acid, isophthalic acid, phthalic acid, and their anhydrides, 2,6-naphthalene dicarboxylic acid, and 2,7-naphthalene dicarboxylic acid and their anhydrides, saturated aliphatic dicarboxylic acids such as succinic acid, adipic acid, azelaic acid, sebacic acid, and dodecane dicarboxylic acid and their anhydrides, alicyclic dicarboxylic acids such as 1,4-dichlorohexane dicarboxylic acid and their anhydrides, lactones such as γ-butyrolactone and ε-caprolactone, aromatic oxymonocarboxylic acids such as p-hydroxyethoxy benzoic acid and hydroxycarboxylic acids corresponding thereto. The acidic component may be used either individually or in combinations of 2 or more.

There are no particular restrictions on the aforementioned alcohol component, with examples including aliphatic glycols having a side chain such as ethylene glycol, 1,3-propane diol, 1,4-butane diol, 1,5-pentane diol, 1,5-hexane diol, diethylene glycol, triethylene glycol, 1,4-cyclohexane diol, 1,4-cyclohexane dimethanol, bisphenol A-alkylene oxide adducts, bisphenol S-alkylene oxide adducts, 1,2-propane diol, neopentyl glycol, 1,2-butane diol, 1,3-butane diol, 1,2-pentane diol, 2,3-pentane diol, 1,4-pentane diol, 1,4-hexane diol, 2,5-hexane diol, 3-methyl-1,5-pentane diol, 1,2-dodecane diol, and 1,2-octadecane diol, and polyvalent alcohols having a valence of 3 or above such as trimethylol propane, glycerin, and pentaerythritol. These alcohol components may be used either individually or in combinations of 2 or more.

The number-average molecular weight of the aforementioned carboxyl group-containing polyester resin should be 1500-6000. A number-average molecular weight of 2000-5000 is even more preferable. If the aforementioned number-average molecular weight is less than 1500, the performance of the coating film obtained will decrease, causing problems with storage stability of the powder coating. On the other hand, if the number-average molecular weight exceeds 6000, the smoothness of the coating film obtained will decrease.

From the standpoints of blocking resistance and external appearance of the film obtained, the glass transition temperature (Tg) of the aforementioned carboxyl group-containing polyester resin should be 35-100° C., and preferably 50-70° C. The glass transition temperature of the present invention may be determined by using a differential scanning calorimeter (DSC).

The curing agent contained in the heat-curable powder coating composition of the present invention may be used either individually or in combinations of 2 or more.

The amount of the curing agent used should be 0.5-1.5 eq of the functional groups of the curing agent per eq of the functional groups of the resin containing the crosslinkable functional groups that are solid at room temperature of component (A), and preferably 0.7-1.2 eq.

As the fibrous filler (C) used in the heat-curable coating composition of the present invention, one may use a fibrous filler with an aspect ratio of 5-500, and preferably 10-250, with a ratio of 10-100 being even more preferable. The term “aspect ratio” used here refers to the ratio of average fiber length L to average fiber diameter D of the fibrous filler (L/D).

If the aspect ratio is less than 5, sufficient chipping resistance will not be seen, and in order to prevent this, the amount of the filler added must be markedly increased. Moreover, if the aspect ratio exceeds 500, it becomes impossible to achieve uniform dispersion, there is a tendency for the external appearance of the film to decrease, and long-term corrosion resistance also decreases. The average fiber diameter and average fiber length of the fibrous filler can be measured using an optical microscope equipped with a micrometer eyepiece. The average fiber diameter should be 1-20 μm, with a diameter of 3-15 μm being particularly preferred. The average fiber length should be 50-300 μm, with a length of 100-200 μm being particularly preferred.

There are no particular limits on the fibrous filler, provided that it is composed of an insulator, with examples including inorganic fibrous fillers and organic fibrous fillers. Specific examples of inorganic fibrous fillers (inorganic compounds) include calcium metasilicate, potassium titanate, magnesium sulfate, sepiolite, zonolite, aluminum borate, rock wool, and glass fibers. Moreover, specific examples of organic fibrous fillers (organic compounds) include polyoxybenzoyl (PO30B), polyoxynaphthoyl (PON), polyacrylonitrile fibers, aramid fibers, etc. The fibrous filler may be used individually or in combinations of 2 or more.

The content of the fibrous filler (C) should be within the range of 1-100 parts by mass with respect to a total of 100 parts by mass of the resin containing crosslinkable functional groups that are solid at room temperature (A) and the curing agent capable of reacting with said crosslinkable functional groups (B). If the amount is less than 1 part by mass, the improvement in chipping resistance will not be sufficient. Moreover, if it exceeds 100 parts by mass, the external appearance of the film will be impaired, and its long-term corrosion resistance will decrease. It is particularly preferable to add an amount of 5-50 parts by mass of the fibrous filler.

In order to maximize the effect of the fibrous filler (C) an effective means is coupling treatment of the filler interface, particularly in the case of inorganic fibrous fillers. Examples of coupling agents include silane coupling agents, titanate coupling agents, and aluminate coupling agents. In the case of organic fibrous fillers, treatments such as plasma treatment are preferred.

As an example of the heat-expandable resin particles (D) used in the heat-curable coating composition of the present invention, one can mention microspheres composed of a thermoplastic resin shell enclosing a liquefied gas, which are characterized by the fact that when they are heated, the gas pressure inside the shell increases, the thermoplastic resin shell softens and expands, and hollow spherical particles are formed. The average particle diameter of the heat-expandable resin particles (D) should be 5-30 μm. Moreover, the volume of the heat-expandable resin particles (D) after expansion should preferably be increased by a factor of 30-150.

Examples of commercial heat-expandable resin particles (D) include Expancel 092DU40, Expancel 092DU80, and Expancel 009DU80, manufactured by Japan Fillite Co., Ltd., and M520 and M520D microspheres manufactured by Dainichiseika Color and Chemicals Mfg. Co., Ltd.

The heat-expandable resin particles (D) may be used individually or in combinations of 2 or more.

The content of the heat-expandable resin particles (D) should be within the range of 0.1-20 parts by mass with respect to a total of 100 parts by mass of the resin-containing crosslinkable functional groups that are solid at room temperature (A) and the curing agent capable of reacting with said crosslinkable functional groups (B). A particularly preferable content of the heat-expandable resin particles (D) is 0.5-15 parts by mass. If the content of the heat-expandable resin particles (D) is less than 0.1 part by mass, the improvement in chipping resistance will be insufficient. Moreover, if it exceeds 20 parts by mass, too many hollow portions will be formed inside the coating film, conversely reducing its chipping resistance.

In order to enhance the effect of the heat-expandable resin particles, prefoamed organic hollow resin particles and inorganic hollow particles (hollow balloons) may be included in the heat-curable coating composition of the present invention.

Examples of such hollow particles include polyacrylonitrile resin-type hollow particles, phenol resin-type hollow particles, and silica resin-type hollow particles.

The heat-curable coating composition of the present invention may also contain plasticizers, coloring pigments, thermal stabilizers, optical stabilizers, matting agents, defoaming agents, leveling agents, thixotropic agents, ultraviolet absorbers, surface control agents, curing accelerators, dispersants, viscosity control agents, antistatic agents, waxes, etc.

There are no particular restrictions on the aforementioned coloring pigments, with examples including titanium dioxide, carbon black, graphite, iron oxide, lead oxide, chrome yellow, phthalocyanine blue, phthalocyanine green, quinacridone, perilene, aluminum powder, alumina powder, bronze powder, copper powder, tin powder, mica, and natural and synthetic mica.

In order to control the heat-curable powder coating composition of the present invention, one may carry out manufacturing by the so-called dry method using melt kneaders such as hot rollers or extruders or by the so-called dry method, which involves melt dispersion in a solvent, followed by removal of the solvent by vacuum distillation or thin film distillation and pulverization.

The heat-curable powder coating composition of the present invention may be obtained by any method commonly known in the art, such as the electrostatic coating method or the flow immersion method to obtain a coating film thickness on the surface of the coated object of 50-800 μm, and preferably 100-400 μm, and by carrying out baking, ordinarily at a temperature of 140-180° C. for a period of 5 minutes to 2 hours, one can obtain a sufficiently cured foamed film.

### WORKING EXAMPLES

We will now explain the invention in detail by means of working examples, but the invention is by no means limited by these examples.

### Working Examples 1-12, Comparison Examples 1-4

Using the various heat-curable powder coating compositions shown in Working Examples 1-12 in Tables 1 and 2 and Comparison Examples 1-4 in Table 3 as raw materials, the materials were uniformly mixed for 1 minute in a dry blender (product name: Henschel mixer, manufactured by Mitsui Mining Co., Ltd.), after which melt kneading was carried out at a temperature of 80-100° C. in an extrusion kneader (product name: Busco Kneader PR46, manufactured by Coperion Corp.), and after cooling, the product was pulverized into fine particles using a hammer-type impact pulverizer. After this, it was filtered through a 150 mesh screen and classified to obtain various heat-curable powder coating compositions.

The figures in the following table are given in units of parts by mass.

TABLE 1

| | | Working | Working | Working | Working | Working | Working |
|---|---|---|---|---|---|---|---|
| | | Example 1 | Example 2 | Example 3 | Example 4 | Example 5 | Example 6 |
| Resin (A) | Epikote 1004 1) | 95.5 | 97.8 | 89.5 | | 48.85 | 82 |
| | Epikote 1003 2) | | | | 94.5 | | |
| | Epotohto YR693 3) | | | | | 48.85 | |
| Curing | Dihydrazide adipate | 4.5 | | | 5.5 | | |
| Agent (B) | Dicyandiamide | | 2.2 | | | 2.3 | |
| | DDA 4) | | | 10.5 | | | |
| | Epicure 171N 5) | | | | | | 18 |
| | P2064 6) | | | | | | |
| Fibrous | CMF150 7) | 20 | 20 | | 20 | 20 | |
| filler (C) | NYGLOS 12 8) | | | 20 | | | 20 |
| Heat- | M520D | 1 | 1 | 1 | | 1 | |
| expandable | microspheres 9) | | | | | | |
| resin | Expancel | | | | 1 | | 1 |
| particles (D) | 092DU40 10) | | | | | | |
| Curing | Amicure PN-23 11) | 1 | 1 | 1 | 1 | 1 | 1 |
| accelerator | | | | | | | |
| Leveling | Resimix RL-4 12) | 0.5 | 0.5 | 0.5 | 0.5 | 0.5 | 0.5 |
| agent | | | | | | | |
| Pigment | Carbon black | 2 | 2 | 2 | 2 | 2 | 2 |

TABLE 2

| | | Working | Working | Working | Working | Working | Working |
|---|---|---|---|---|---|---|---|
| | | Example 7 | Example 8 | Example 9 | Example 10 | Example 11 | Example 12 |
| Resin (A) | Epikote 1004 1) | 95.5 | 97.8 | 89.5 | | | 57.7 |
| | Epikote 1003 2) | | | | 75.8 | 29.3 | |
| | Epotohto YR693 3) | | | | 18.9 | 68.3 | |
| Curing | Dihydrazide adipate | 4.5 | | | 5.3 | | |
| Agent (B) | Dicyandiamide | | 2.2 | | | 2.4 | |
| | DDA 4) | | | 10.5 | | | |
| | Epicure 171N 5) | | | | | | |
| | P2064 6) | | | | | | 42.3 |
| Fibrous | CMF150 7) | 50 | | 20 | | 20 | 20 |
| filler (C) | NYGLOS 12 8) | | 20 | | 5 | | |
| Heat- | M520D | | | | | | |
| expandable | Microspheres 9) | | | | | | |
| resin | Expancel | 1 | 5 | 10 | 5 | 5 | 5 |
| particles (D) | 092DU40 10) | | | | | | |
| Curing | Amicure PN-23 11) | 1 | 1 | 1 | 1 | 1 | 1 |
| accelerator | | | | | | | |
| Leveling | Resimix RL-4 12) | 0.5 | 0.5 | 0.5 | 0.5 | 0.5 | 0.5 |
| agent | | | | | | | |
| Pigment | Carbon black | 2 | 2 | 2 | 2 | 2 | 2 |

TABLE 3

| | | Comparison | Comparison | Comparison | Comparison |
|---|---|---|---|---|---|
| | | Example 1 | Example 2 | Example 3 | Example 4 |
| Resin (A) | Epikote 1004 1) | 95.46 | 97.74 | 89.3 | |
| | Epikote 1003 2) | | | | 47.56 |
| | Epotohto YR693 3) | | | | 47.56 |
| Curing | Dihydrazide adipate | 4.54 | | | 4.88 |
| Agent (B) | Dicyandiamide | | 2.26 | | |
| | DDA 4) | | | 10.7 | |
| | Epicure 171N 5) | | | | |
| Fibrous | CMF150 7) | | 150 | 20 | |
| filler (C) | NYGLOS 12 8) | | | | 20 |
| Heat- | M520D | 1 | | | 30 |
| expandable | microspheres 9) | | | | |
| resin | Expancel | | 1 | | |
| particles (D) | 092DU40 10) | | | | |
| Curing | Amicure PN-23 11) | 1 | 1 | 1 | 1 |
| accelerator | | | | | |
| Leveling | Reasimix RL-4 12) | 0.5 | 0.5 | 0.5 | 0.5 |
| agent | | | | | |
| Pigment | Carbon black | 2 | 2 | 2 | 2 |

1) Product name: manufactured by Japan Epoxy Resin Co., epoxy resin, epoxy equivalent 925 g/eq, softening point 97° C.

2) Product name: manufactured by Japan Epoxy Resin Co., epoxy resin, 750 g/eq, softening point 89° C.

3) Product name: manufactured by Tohto Kasei Co., Ltd., polymer microparticle dispersion-type epoxy resin, core-shell structure, epoxy equivalent 910 g/eq, softening point 97° C., average particle diameter of polymer microparticles having a core-shell structure 0.5 μm, content of polymer microparticles having a core-shell structure 12.5% by mass

4) Product name: manufactured by Ube Kosan Co., Ltd., 1,10-dodecane carboxylic acid

5) Product name: manufactured by Japan Epoxy Resin Co., phenol resin, phenolic OH 4.0 meq/g

6) Product name: manufactured by DSM, carboxyl group-containing polyester resin, acid value 85 mg KOH/g, number-average molecular weight 2200, glass transition temperature 71° C.

7) Product name: manufactured by Taiheyo Material Corp., rock wool, average fiber length 135 μm, average particle diameter 5 μm, aspect ratio 27

8) Product name: manufactured by Nyco Minerals, Inc., calcium metasilicate, average fiber length 156 μm, average fiber diameter 12 μm, aspect ratio 13

9) Product name: manufactured by Dainichiseika Color and Chemicals Mfg. Co., Ltd., heat-expandable resin beads, particle diameter 14 μm

10) Product name: manufactured by Japan Fillite Co., Ltd., heat-expandable resin beads, average particle diameter 13 μm

11) Product name: manufactured by Ajinomoto Fine-Techno Co., Inc., amine adduct curing accelerator

12) Product name: manufactured by Mitsui Chemicals, Inc., acrylic surface control agent

The powder coatings obtained were applied with a film thickness of 200-400 μm to a soft steel plate 2.3 mm in thickness subjected to zinc sulfite treatment by means of electrostatic coating with a charge of −80 KV, and baking was carried out at 160° C. for 20 minutes to obtain the respective test pieces.

The various test pieces were tested, and these results are shown in Tables 4, 5, and 6.

The film properties were evaluated as follows:

(1) Foaming

The coating film was observed under an optical microscope after baking and evaluated according to the following standards.

◯: Foam shows individual air bubbles having a diameter of 100 microns or less.

Δ: Foam shows continuous air bubbles or air bubbles having a diameter of 100 microns or more.

x: No foaming.

(2) Adhesion (According to JIS K5600 5-6)

100 notches were made in the coated surface using a knife at intervals of 1 mm, cellophane tape was applied to the surface and then vigorously peeled off, and the number of remaining pieces of coating film was counted and evaluated.

◯: Number of remaining pieces of coating film after tape peeling is 100/100.

Δ: Number of remaining pieces of coating film after tape peeling is 70-99/100.

x: Number of remaining pieces of coating film after tape peeling is 69 or less/100.

(3) Impact Resistance (According to JIS K5600 5-3)

The test piece was positioned with the coated surface facing upward, a 500 g weight was dropped onto it from a height of 50 cm, and the extent of cracking of the film was evaluated.

◯: No cracking

Δ: Slight cracking

x: Pronounced cracking

(4) Saltwater-Spray Resistance (According to JIS K5600 7-1)

A coated plate crosscut in advance was placed for 960 hours in a saltwater-spray testing unit under conditions of 35° C. and 5% NaCl, and after removal, the width of unilateral swelling from the crosscut surface and the width of unilateral peeling caused by cellophane tape were evaluated.
⊚: Width of unilateral swelling and peeling is 1 mm or less.

◯: Width of unilateral swelling and peeling is 1-3 mm.

Δ: Width of unilateral swelling and peeling is 3-5 mm.

x: Width of unilateral swelling and peeling exceeds 5 mm.

(5) Moisture Resistance (According to JIS K5600 7-2)

A coated plate was placed for 960 hours in a moisture-resistant testing unit under conditions of 50° C. and 95% RH, and the adhesion of the material to the film was evaluated based on the number of remaining pieces of coating film using cellophane tape.

◯: Number of remaining pieces of coating film after tape peeling is 100/100.

Δ: Number of remaining pieces of coating film after tape peeling is 70-99/100.

x: Number of remaining pieces of coating film after tape peeling is 69 or less/100.

(6) Low-Temperature Chipping Resistance

A coated test piece was placed for 6 hours or more in a low temperature, constant temperature unit at −30° C., chipping was carried out using a gravelometer, and the extent of peeling was evaluated. Chipping was carried out with No. 6 crushed stone (200 g) at an air pressure of 0.5 MPa.

*: No peeling reaching the substrate.
⊚: Peeling reaching the substrate, with peeling area of 1 mm² or less.

◯: Peeling reaching the substrate, with peeling area greater than 1 mm² and less than 3 mm².

Δ: Peeling reaching the substrate, with peeling area greater than 3 mm² and less than 10 mm².

x: Peeling reaching the substrate, with peeling area exceeding 10 mm².

TABLE 4

| | Working | Working | Working | Working | Working | Working |
|---|---|---|---|---|---|---|
| | Example 1 | Example 2 | Example 3 | Example 4 | Example 5 | Example 6 |
| Foaming | ◯ | ◯ | ◯ | ◯ | ◯ | ◯ |
| Adhesion | ◯ | ◯ | ◯ | ◯ | ◯ | ◯ |
| Impact | ◯ | ◯ | ◯ | ◯ | ◯ | ◯ |
| resistance | | | | | | |
| Saltwater- | ⊚ | ◯ | ◯ | ◯ | ⊚ | ⊚ |
| spray | | | | | | |
| resistance | | | | | | |
| Moisture | ◯ | ◯ | ◯ | ◯ | ◯ | ◯ |
| resistance | | | | | | |
| Chipping | ⊚ | ◯ | ◯ | ◯ | * | ◯ |
| resistance | | | | | | |

TABLE 5

| | Working | Working | Working | Working | Working | Working |
|---|---|---|---|---|---|---|
| | Example 7 | Example 8 | Example 9 | Example 10 | Example 11 | Example 12 |
| Foaming | ◯ | ◯ | ◯ | ◯ | ◯ | ◯ |
| Adhesion | ◯ | ◯ | ◯ | ◯ | ◯ | ◯ |
| Impact | ◯ | ◯ | ◯ | ◯ | ◯ | ◯ |
| resistance | | | | | | |
| Saltwater- | ⊚ | ◯ | ◯ | ◯ | ◯ | ◯ |
| spray | | | | | | |
| resistance | | | | | | |
| Moisture | ◯ | ◯ | ◯ | ◯ | ◯ | ◯ |
| resistance | | | | | | |
| Chipping | ⊚ | ⊚ | ◯ | ⊚ | * | ◯ |
| resistance | | | | | | |

TABLE 6

| | Comparison | Comparison | Comparison | Comparison |
|---|---|---|---|---|
| | Example 1 | Example 2 | Example 3 | Example 4 |
| Foaming | ∘ | ∘ | x | ∘ |
| Adhesion | ∘ | ∘ | ∘ | Δ |
| Impact | ∘ | x | ∘ | ∘ |
| resistance | | | | |
| Saltwater- | ∘ | x | ∘ | ∘ |
| spray | | | | |
| resistance | | | | |
| Moisture | ∘ | ∘ | ∘ | ∘ |
| resistance | | | | |
| Chipping | x | ∘ | x | Δ |
| resistance | | | | |

In Working Examples 1-12, foaming, adhesion, impact resistance, saltwater-spray resistance, moisture resistance, and chipping resistance were all favorable, and in Working Examples 5 and 11, in which a polymer microparticle dispersion-type epoxy resin having a core-shell structure with a specified ratio was used, chipping resistance was quite outstanding. In Comparison Examples 1 and 2, 1 part by mass or less and 100 parts by mass or more of the fibrous fillers (C) respectively were mixed in with respect to a total of 100 parts by mass of the curing agent (B) capable of reacting with the epoxy resin (A), and in Comparison Examples 3 and 4, the heat-expandable resin particles (D) were mixed in in amounts of 0.1 part by mass or less and 20 parts by weight or more respectively; the film of Comparison Example 1 showed foaming properties and favorable adhesion, impact resistance, saltwater-spray resistance, and moisture resistance, but in the chipping resistance test, pronounced peeling of the film was observed. In Comparison Example 2, the film showed favorable chipping resistance, but because excess amounts of filler were mixed in, adhesion to the substrate was poor, and in the impact resistance and saltwater-spray resistance tests, peeling was seen. In Comparison Example 3, the foaming properties of the coating film were poor, and sufficient chipping resistance was not achieved. In Comparison Example 4, durability with respect to impact was achieved because of sufficient foaming properties, but adhesion was somewhat poor.

1. A heat-curable powder coating composition, comprising a resin containing crosslinkable functional groups that are solid at room temperature (A), a curing agent capable of reacting with these crosslinkable functional groups (B), a fibrous filler (C), and heat-expandable resin particles (D).

2. The heat-curable powder coating composition of claim 1, comprising 1-100 parts by mass of the fibrous filler (C) and 0.1-20 parts by mass of the heat-expandable resin particles (D) with respect to a total of 100 parts by mass of the resin containing crosslinkable functional groups that are solid at room temperature (A) and the curing agent capable of reacting with said crosslinkable functional groups (B).

3. The heat-curable powder coating composition of claim 1, wherein the resin containing crosslinkable functional groups that are solid at room temperature (A) comprises an epoxy resin, and the curing agent capable of reacting with said crosslinkable functional groups (B) comprises at least one substance selected from an amine, polyamine, dihydrazide, dicyandiamide, imidazole, or phenol resin, a carboxyl group-containing polyester resin, a dibasic acid, and an acid anhydride.

4. The heat-curable powder coating composition of claim 1, comprising the fibrous filler (C) having an average fiber diameter of from 1-30 μm, an average fiber length of from 50 μm-500 μm, and an aspect ratio of from 5-500.

5. The heat-curable powder coating composition of claim 1, wherein the resin containing crosslinkable functional groups that are solid at room temperature (A) comprises an epoxy resin comprising from 1-50 parts by weight of polymer microparticles having a core-shell structure with respect to 100 parts by weight of the epoxy resin.
